(19) United States
(12) Patent Application Publication
(10) Pub. No.: US 2009/0304010 A1
(43) Pub. Date: Dec. 10, 2009

(54) Network element providing an interworking function between plural networks, and system and method including the network element

(75) Inventors: Rintaro Kurebayashi, Herndon, VA (US); Yoshihiko Suemura, Herndon, VA (US); Osamu Matsuda, Herndon, VA (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Corpoation of America, Irving, TX (US)

(21) Appl. No.: 12/155,655

(22) Filed: Jun. 6, 2008

(51) Int. Cl. H04L 12/56

(52) U.S. Cl. 370/401

(57) ABSTRACT

A network element provides an interworking function between plural networks. The network element includes a first network forwarding function block for forwarding packets in a first network, a first network control function block for controlling the first network forwarding function block, a second network forwarding function block for forwarding frames along a connection-oriented path in a second network, and a second network control function block for controlling the second network forwarding function block.

### BACKGROUND OF THE INVENTION

1. Field of the Invention The present invention relates to a network element and, more particularly, a network element providing an interworking function between plural networks.

2. Description of the Related Art

Historically a service network, such as an Internet Protocol/multi-protocol label switching (IP/MPLS) network, and a transport network such as a synchronized optical network/synchronous digital hierarchy (SONET/SDH) or optical transport network (OTN) are independently managed. Operators of service network setup (e.g., prepare) service instances, such as multi-protocol label switching label switched path (MPLS LSP), and route them through transport instances, such as SONET/SDH paths provided by the transport network. Connectivity and bandwidth of the transport instances are negotiated between operators of the service and transport networks.

If the operators of the service network find that additional bandwidth or a new connection of the transport instance is required, then they order it to the operators of the transport network. On the other hand, the operators of the transport network cannot monitor the actual bandwidth of the service instances in the transport instances, so they need to wait for the order from the operators of the service network or predict it based on past ordering information from them for increasing bandwidth or setting up new transport instances.

Related art systems may provide suitable architecture for transporting packets to the transport network, in part by introducing a concept of connection-oriented paths to packet networks through Provider Backbone Bridge Traffic Engineering (PBB-TE) and Transport MPLS (T-MPLS) to the transport instances.

FIG. 1 illustrates a related art optical network 1001 which contains external Internet Protocol (IP) networks 1002A1, 1002A2, 1002B1, 1002B2 through the use of optical edge routers (ERs) 1003A1, 1003A2, 1003B1, 1003B2. An optical path 1005 is established among the optical, edge routers 1003 through optical cross connect devices 1004a, 1004b, and border gateway protocol (BGP) peers 1006 are established among the optical edge routers 1003 for exchanging route information of the external IP networks 1002.

### SUMMARY OF THE INVENTION

In view of the foregoing and other problems, disadvantages, and drawbacks of the aforementioned assemblies and methods, it is an exemplary feature of the present invention to provide a network element for providing an interworking function between plural networks.

A problem with related art networks (e.g., the network 1001 of FIG. 1) is that since a transport network tends to be managed based on centralized management instead of distributed management, interworking between networks (e.g., a service network such as an IP/MPLS network and a transport network) which is suited to the current management style does not exist. As a result, reduction of service installation time and accuracy of predicting required bandwidth of transport instances are limited by the manual negotiation between the networks (e.g., between a service network and a transport network).

The present invention may address these and other problems of the related art systems.

An exemplary aspect of the present invention is directed to an apparatus including a network element providing an interworking function between plural networks. The network element includes a first network forwarding function block for forwarding packets in a first network, a first network control function block for controlling the first network forwarding function block, a second network forwarding function block for forwarding frames along a connection-oriented path in a second network, and a second network control function block for controlling the second network forwarding function block.

Another exemplary aspect of the present invention is directed to a system including plural network elements providing an interworking function between plural networks. The plural network elements include a first network forwarding function block for forwarding packets in a first network, a first network control function block for controlling the first network forwarding function block, a second network forwarding function block for forwarding frames along a connection-oriented path in a second network, and a second network control function block for controlling the second network forwarding function block. The system also includes a centralized control plane in communication with the plural network elements.

Another exemplary aspect of the present invention is directed to an apparatus including a network element providing an interworking function between plural networks. The network element includes a first network forwarding function block for forwarding packets in a first network, a first network control function block for controlling the first network forwarding function block, a second network forwarding function block for forwarding frames along a connection-oriented path in a second network, a second network control function block for controlling the second network forwarding function block, and an interworking function block for interworking with the first network and second network control function blocks.

Another exemplary aspect of the present invention is directed to a method which includes setting up a transport instance by one of a centralized control function block and a second network control function block in plural network elements, setting up a service instance by a first network control function block in the plural network elements, based on information of the transport instance, forwarding packets in a first network by using a first network forwarding function block of a network element in the plural network elements which is controlled by the first network control function block, and forwarding frames which encapsulate packets in a second network by using a second network forwarding function block of a network element in the plural network elements which is controlled by the second network control function block.

Another exemplary aspect of the present invention is directed to a programmable storage medium tangibly embodying a program of machine-readable instructions executable by a digital processing apparatus to perform the method of the present invention.

With its unique and novel features, the present invention provides an apparatus including network element providing an interworking function between plural networks including, for example, a service network which is managed by distributed management, and a transport network which is managed by a centralized management.

### BRIEF DESCRIPTION OF THE DRAWINGS

The foregoing and other objects, aspects and advantages will be better understood from the following detailed description of the embodiments of the invention with reference to the drawings, in which:

FIG. 1 illustrates an optical network 1001 according to the related art;

FIG. 2 illustrates a network element 200, in accordance with an exemplary aspect of the present invention;

FIG. 3 illustrates a system 200, in accordance with an exemplary aspect of the present invention;

FIG. 4 illustrates systems 400, 450, in accordance with an exemplary aspect of the present invention;

FIG. 5 illustrates a setup configuration 500 of LSPs and connection-oriented paths, in accordance with an exemplary aspect of the present invention;

FIG. 6A illustrates setup configuration 600 of LSPs and connection-oriented paths, in accordance with another exemplary aspect of the present invention;

FIG. 6B illustrates setup configuration 650 of LSPs and connection-oriented paths, in accordance with another exemplary aspect of the present invention;

FIG. 7 illustrates another network element 700, in accordance with an exemplary aspect of the present invention;

FIG. 8 illustrates another system 800, in accordance with an exemplary aspect of the present invention;

FIG. 9 illustrates a method 900, in accordance with an exemplary aspect of the present invention;

FIG. 10 illustrates a control function block 1000 (e.g., second network control function block 240) which may be included in the network element (e.g., network element 200), according to an exemplary aspect of the present invention; and

FIG. 11 illustrates a forwarding function block 1100 (e.g., forwarding function block 230) which may be included in the network element (e.g., network element 200), according to an exemplary aspect of the present invention.

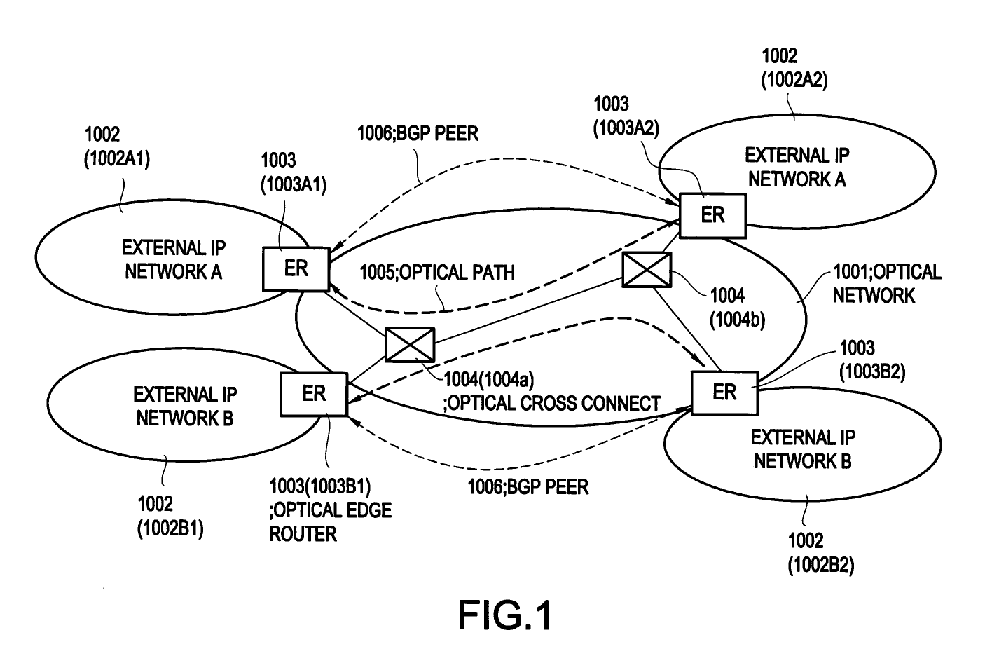

### DETAILED DESCRIPTION OF THE EMBODIMENTS OF THE INVENTION

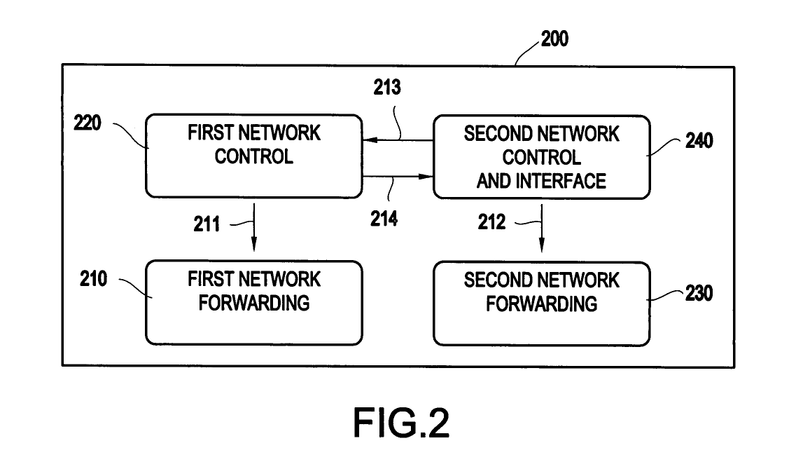

Referring now to the drawings, FIGS. 2-11 illustrate the exemplary aspects of the present invention.

In particular, FIG. 2 illustrates a network element (NE) 200 according to an exemplary aspect of the present invention. The network element 200 may be included in an apparatus and should not be construed as only being software-implemented but may also be implemented by hardware or a combination of software and hardware.

As illustrated in FIG. 2, the network element 200 includes a first network forwarding function block 210 for forwarding packets in a first network (e.g., a service network such as an IP/MPLS network), a first network control function block 220 for controlling the first network forwarding function block, a second network forwarding function block 230 for forwarding frames along a connection-oriented path in a second network (e.g., a transport network such as an SONET/SDH or an OTN), and a second network control function block 240 for controlling the second network forwarding function block.

The network element 200 may be used, for example, in an optical packet transport product, a Layer 2 switch, or a time division multiplexed (TDM) switch, but these are simply examples and should not be considered as limiting the present invention in any way.

In an exemplary aspect of the present invention, the second network control function block 240 may include a mechanism for communicating with a centralized control plane for the second network. That is, the second network control function block 240 may also include an interface between the network element 200 and a centralized control plane.

The term “centralized control plane” as used herein may be defined, for example, as hardware and/or software for controlling (e.g., monitoring and administering) the operations of plural network elements 200 in a network.

It should be noted that for ease of discussion, the terms “service network” and “transport network” may at times be used herein to identify the “first network” and “second network”, respectively. However, these terms are merely exemplary and should not be considered as limiting. That is, the “first network” is not limited to a “service network” but may include another type of network other than a “service network”, and the “second network” is not limited to a “transport network” but may include another type of network other than a “transport network”.

The network element 200 may provide an interworking functionality between plural networks (e.g., between a service network such as an IP/MPLS network which is managed by distributed management, and a transport network which is managed by centralized management). In particular, the interworking functionality may enable a transport network, which has been operated based on centralized management such as Network Management Systems (NMSs), to monitor status of a service instance such as a total bandwidth of service instances in a transport instance, such that an operator of the transport network can plan to increase bandwidth of a transport instance accurately with appropriate timing.

In addition, the increased bandwidth of transport instances may be automatically communicated (e.g., advertised) from the transport network into the service network by a routing protocol, eliminating a need for the operator of the service network to manually configure additional bandwidth of transport instances in the service network.

That is, the network element 200 of the present invention may allow an operator of the transport network to plan to increase bandwidth of transport instances accurately with appropriate timing, and may allow operators of the service network to avoid having to configure the service network to reflect changes of bandwidth of transport instances. That is, an important feature of the network element 200 of the present invention is that it may support a service network functionality and a transport network functionality.

It should be noted that although the present invention may be described herein with respect to setting or changing a “bandwidth”, the present invention should not be considered as limited to this. In fact, the network element 200 may also be used for setting or changing other features such as quality of service (QoS), etc.

As noted above, the service network functionality includes control function block 220 and forwarding function block 210, and the transport network functionality includes a control function block 240 and forwarding function block 230. The control function block 220 of the service network functionality controls the service network forwarding function block 210 and the control function block 240 of the transport network functionality controls the transport network forwarding function block 230. Further, the service network control function block 220 may typically support a traffic engineering (TE) function such as TE signaling and routing.

The term “traffic engineering” may be defined, for example, as including two (2) functionalities: 1) a link state advertisement, and 2) designation of an explicit path (e.g., specifying explicit routing).

The service network control function block 220 and the transport network control function block 210 may interwork with each other. For example, the service network control function block 220 may include a mechanism for recognizing a bandwidth of the service instances and communicate the bandwidth to the transport network control function block 240, and the transport network control function block 240 may include a mechanism for controlling a bandwidth of the transport instances based on the bandwidth of the service instances communicated from the service network control function block 220. Further, the transport network control function block 240 may include a mechanism for notifying an available bandwidth of transport instances to the service network control function block 220, and the service network control function block 220 may include a mechanism for communicating (e.g., advertising) the available bandwidth to the service network.

Separate transport network instances in the network element 220 may be used for tunneling service network instances depending on service type such as IP/MPLS and Ethernet. This may simplify bandwidth management of the transport instances.

Referring again to FIG. 2, in the network element 200, the first network control function block 220 (e.g., a service network control function block such as an IP/MPLS control function block) may control packet forwarding (211) (e.g., IP/MPLS packet forwarding) which is implemented in the first network forwarding function block 210 (e.g., a service network forwarding function block such as an IP/MPLS forwarding function block). The first network control function block 220 may set up (e.g., configure) a packet forwarding table and a bandwidth of Label Switched Paths (LSPs) used for forwarding the packets. The LSPs may be set up (e.g., configured) either by a centralized Network Management System (NMS) or by a distributed control plane, using protocols such as Label Distribution Protocol (LDP), Open Shortest Path First Traffic Engineering (OSPF-TE), and Resource Reservation Protocol Traffic Engineering (RSVP-TE).

The second network control function block 240 (e.g., a transport network control function block such as a layer 1 or layer 2 control function block) works to control frames (e.g., layer 1 or layer 2 frames such as Ethernet frames and SONET/SDH frames), controlling to forward the frames through a connection-oriented path established by a scheme such as provider backbone bridge-traffic engineering (PBB-TE), transport-multi-protocol label switching (T-MPLS), SONET/SDH, and OTN at the second network forwarding function block 230 (e.g., a transport network forwarding function block such as a layer 1 or layer 2 forwarding function block).

The second network control function block 240 may control forwarding (212) of frames in the second network. The set up of a connection-oriented path can be implemented either by a centralized NMS, or by distributed control such as Generalized MPLS (GMPLS). The frames are forwarded along with the connection-oriented path under the control of the second network control function block 240.

A connection-oriented path may be used for forwarding packets (e.g., IP/MPLS packets) by functioning as a “tunnel” for the packets. An interworking function between first network control function block 220 and second network control function block 240 may include a function 213 for enabling the first network control function block 220 to find a connection-oriented path available for forwarding packets, and a function 214 for communicating the available bandwidth of the connection-oriented paths for packets to routers using routing protocols such as OSPF-TE.

An LSP cannot be created when total bandwidth of LSPs exceeds the available bandwidth of the connection-oriented path by the bandwidth of the LSP required. The first network control function block 220 of NE 200 may receive from routers a signal which includes bandwidth information of LSPs. The bandwidth information may be communicated to the second network control function block 240 so that it can control the bandwidth of the connection-oriented path based on the LSP bandwidth information with an appropriate policy.

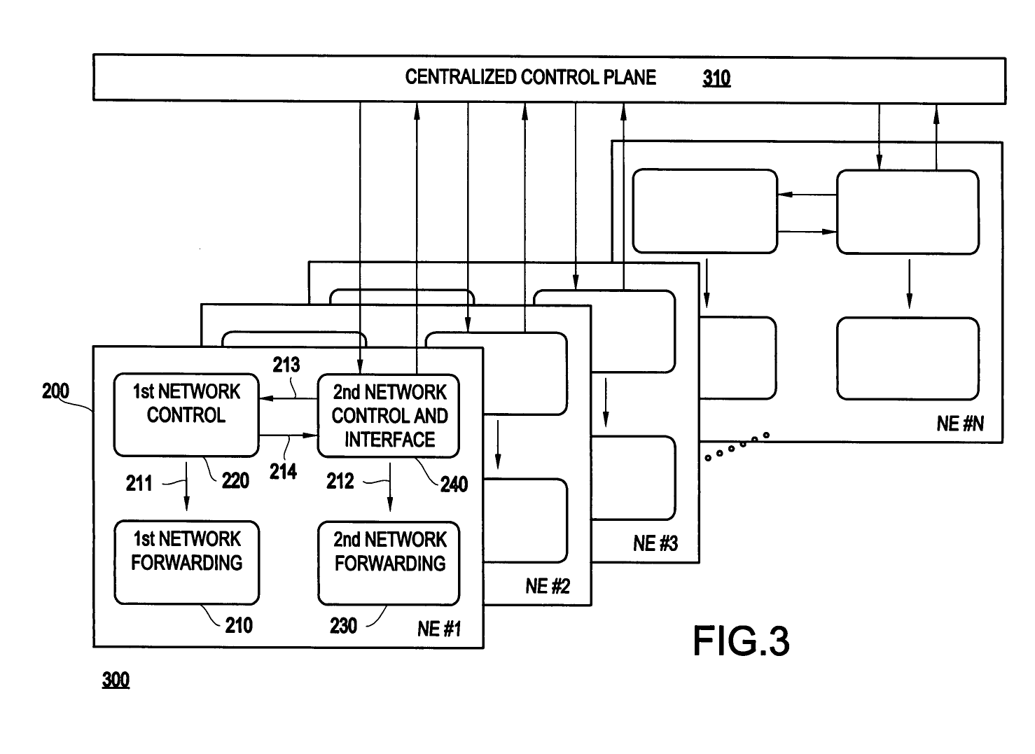

FIG. 3 illustrates a system 300 for, according to an exemplary aspect of the present invention. The system 300 includes plural network elements 200 (NE #1, NE #2, NE #3 . . . NE #N) (e.g., including a structure and function as described above with respect to FIG. 2) which provide an interworking function between plural networks, and a centralized control plane 310 in communication with the plural network elements 200. The second network control function block may also include a mechanism for communicating with the centralized control plane 310.

An important feature of the present invention is that the first network and second network control function blocks (e.g., service network and transport network control function blocks, respectively) and the centralized control plane (e.g., the transport network centralized control plane) may interwork with each other. In particular, the second network control function block 240 may include a mechanism for communicating with the centralized control plane 310 and a mechanism for operating based on orders from the centralized control plane 310, and the centralized control plane 310 may include a mechanism for collecting information from the plural network elements 200 through a second network control function block 240 of at least one of the network elements 200, and a mechanism for ordering an operation to the plural network elements 200 by ordering the operation to the second network control function blocks 240 of the plural network elements.

Further, an important benefit of the present invention is that the centralized control plane gives a stable network. If the first network and the second network are both controlled by distributed control planes, the interworking function may give an unstable behavior to both the first network and the second network in case that one of the networks becomes unstable due to a problem in a control function, for example. The centralized control plane enables the present invention to avoid the unstable behavior since the operator's policy of the transport network can be strictly reflected to the centralized control plane.

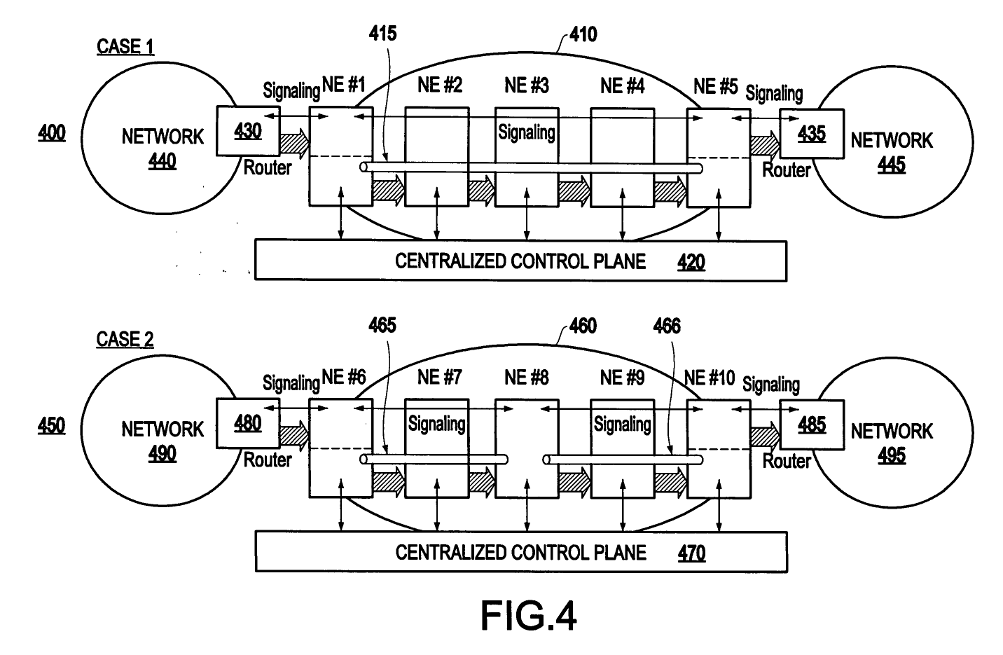

Referring again to the drawings, FIG. 4 illustrates a system 400 (Case 1) including plural network elements providing an interworking function between plural networks according to an exemplary aspect of the present invention, and a system 450 (Case 2) including plural network elements providing an interworking function between plural networks according to another exemplary aspect of the present invention.

In particular, the systems 400, 450 include networks 410, 460, respectively, which include plural network elements 200 (e.g., similar to the network element 200 described above with respect to FIGS. 2 and 3), and the first network control function block 220 and second network control function block 240 may interwork each other as described above with respect to FIGS. 2 and 3.

It should be noted that the network elements 200 (NE #1-NE #10) in FIG. 4 are depicted as having the first network functionality (e.g., first network control function block 220 and first network forwarding function block 210) on top and the second network functionality (e.g., second network control function block 240 and second network forwarding function block 230) on the bottom. That is, the communication with the centralized control planes 420, 470 is performed by the second network control function blocks of the network elements 200.

In addition, the dark arrows in FIG. 4 indicate a direction of packet forwarding in the systems 400, 450. That is, the packets are transported via a connection-oriented path in the second network functionality (e.g., layer 1, layer 2, etc.) in the network elements (NE #1, NE #2, etc.) which may serve as a “tunnel” for forwarding the packets.

In case 1 of FIG. 4, a connection-oriented path 415 maybe set up between NE #1 and NE #5 through NE #2, NE #3 and NE #4. The setup methods of the connection-oriented path include, but are not limited to, manual path setting by the centralized control plane such as NMS, and by automatic setting by the centralized control plane based on policies of network management. Attributes of the connection-oriented path, such as end-points and available bandwidth, may be communicated to routers 430, 435 connected to NE #1 and NE #5, respectively, through routing protocols such as OSPF-TE, and thus human intervention is not required for communicating a change of the connection-oriented path 415.

Routers 430, 435 which are connected to networks 440 and 445 (e.g., IP/MPLS networks), respectively, and connected to NE #1 and NE #5, respectively, can set up LSPs based on the attributes of the connection-oriented path obtained by the NEs 200. The LSPs may be set up by signaling protocols such as RSVP-TE and LDP. NE #1 and NE #5, which are the edges of the connection-oriented path 415, may function like a router (e.g., an IP/MPLS router) in setting up LSPs into the connection-oriented path 415, using first network control function block functionalities (e.g., IP/MPLS control function block functionalities) in the NEs. At NE #2, NE #3 and NE #4, incoming packets from NE #1 may be forwarded to NE #5 by the connection-oriented path 415, without processing of the packet headers (e.g., IP/MPLS packet headers).

It should be noted that other routers (in addition to routers 430, 435 and 480, 485) in the networks (e.g., networks 440, 445, 490, 495) can recognize a connection-oriented path set by the network elements 200 (e.g., NE#1 . . . NE#10). Further, service instances can be set from other routers (in addition to routers 430, 435 and 480, 485) in the networks (e.g., networks 440, 445, 490, 495).

As NE #1 and NE #5 know a bandwidth of LSPs in a connection-oriented path 415 between NE #1 and NE #5, the bandwidth of the connection-oriented path 415 may be managed based on the bandwidth of LSPs in the connection-oriented path 415. The bandwidth of LSPs in the connection-oriented path 415 may be communicated to centralized control plane 420, and a new connection-oriented path may be created, or bandwidth of the connection-oriented path 415 may be expanded manually or automatically by the centralized control plane 420.

On the other hand, the system 450 (Case 2), includes a connection-oriented path 465 which is between NE #6 and NE #8, and another connection-oriented path 466 which is formed between NE #8 and NE #10. The connection-oriented paths 465, 466 are set up for transmitting packets from router 480 to router 485 which are connected to networks 490 and 495 (e.g., IP/MPLS networks), respectively. LSPs may be set up between routers 480, 485 through the two connection-oriented paths 465, 466 by protocols such as LDP and RSVP-TE.

NE #7 and NE #9, which are located between NE #6 and NE #8, and NE #8 and NE #10, respectively, may also recognize the protocols for setting up the LSPs. In forwarding packets (e.g., IP/MPLS packets), NE #8 may look at the header of the packets incoming from NE #7 through the connection-oriented path 465 between NE #6 and NE #8, and forward the packets to NE #9 through the other connection-oriented path 466 between NE #8 and NE #10.

It should also be noted that the network element 200 of the present invention may transport different types of packets such as IP/MPLS packets, and may also transfer frames such as Ethernet frames. The connection-oriented paths for those frames may also be set up in the network elements 200.

FIG. 5 illustrates a setup configuration 500 of LSPs and connection-oriented paths in a physical line such as fiber connecting NEs, according to an exemplary aspect of the present invention. The size 6f the cross sectional area of the cylinders in FIG. 5 indicates the amount of bandwidth of the port 510, bandwidth of the connection-oriented paths 520, and bandwidth of the service instances 530.

The bandwidth of port 510 is typically determined by the line rate, and the bandwidth of the connection-oriented paths 520 may be set separately depending on service instances. The bandwidths of service instances 530, including first service instances 535 (e.g., VLANs) and second service instances 536 (e.g., LSPs) may be independently controlled in different connection-oriented paths, enabling simple fault localization for failures in the service instances.

This configuration 500 may also allow the system of the present invention to avoid invading the bandwidth of each type of service instance, as the bandwidths of each type of service instance may be limited by the bandwidth of the connection-oriented paths assigned to them separately. The bandwidth of the port 510 where connection-oriented paths are not assigned can be used for packet transmission with best effort.

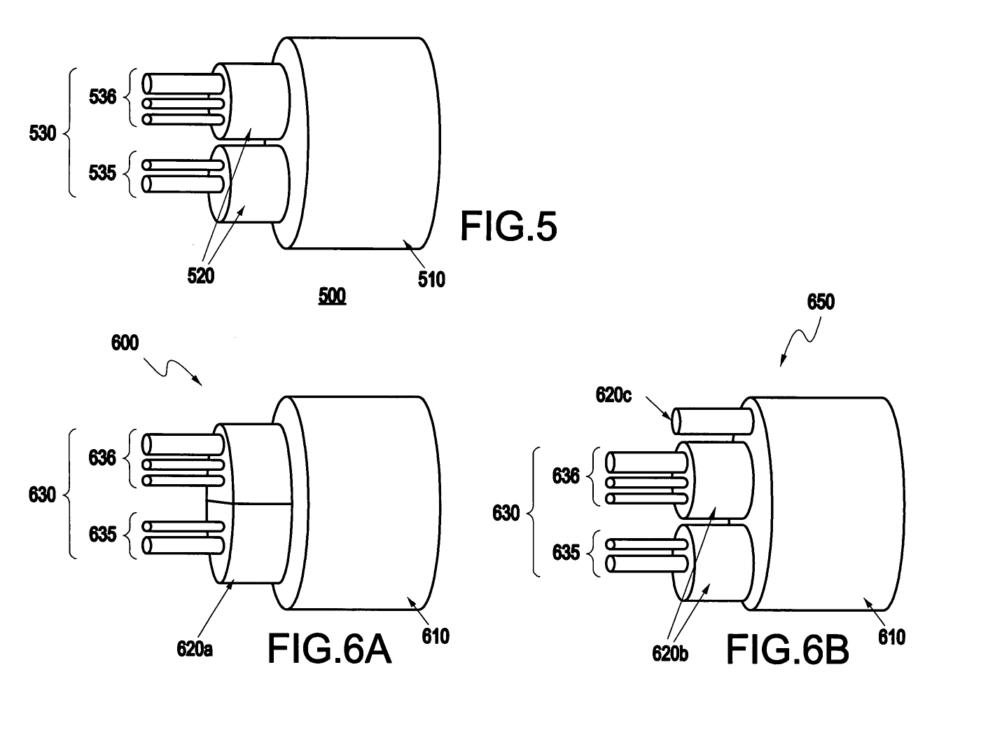

FIG. 6A illustrates another configuration 600 of service instances and connection-oriented paths, according to the exemplary aspects of the present invention. The configuration 600 may be described as including a common connection-oriented path service instances (e.g., LSP and VLAN), and the configuration 650 may be described as including a separate connection-oriented path for a control packet (e.g., an MPLS control packet).

In particular, configuration 600 includes a port bandwidth 610 and bandwidth of service instances 630 including first service instances 635 (e.g., VLANs) and second service instances 636 (e.g., LSPs). Further, in configuration 600, each type of service instance (e.g., LSPs and VLANs) may be accommodated in a single connection-oriented path 620a. The bandwidths of the types of service instances can be independently controlled in this case, too, by setting maximum bandwidths of the service instances for each type separately in the NEs 200 at the edge of the connection-oriented path 620a and referring to the available bandwidth of the service instances for each type at those NEs 200 when a new service instance is newly created. This configuration 600 may reduce the number of connection-oriented paths, and may reduce the workload for processing at intermediate nodes where packets and frames are forwarded by connection-oriented paths.

FIG. 6B illustrates another configuration 650 of service instances and connection-oriented paths, according to the exemplary aspects of the present invention. The configuration 650 similarly includes a port bandwidth 610 and bandwidth of service instances 630 including first service instances 635 (e.g., VLANs) and second service instances 636 (e.g., LSPs). Further, in configuration 650, each type of service instance (e.g., LSPs and VLANs) may be accommodated in connection-oriented path 620b. However, in contrast to configuration 600, in configuration 650, the control packets (e.g., IP/MPLS control packets) may be separately managed by a different connection-oriented path 620c. By this configuration 650, the bandwidth used for the control packets is limited to the bandwidth of the connection-oriented path 620c which tunnels the control packets, even if there is a problem in the routers (e.g., routers 430, 435 in FIG. 4) or a network element 200 and a lot of control packets are sent from them. This configuration 650 also may avoid an expansion of trouble caused by routers to other types of packets and frames such as Ethernet frames.

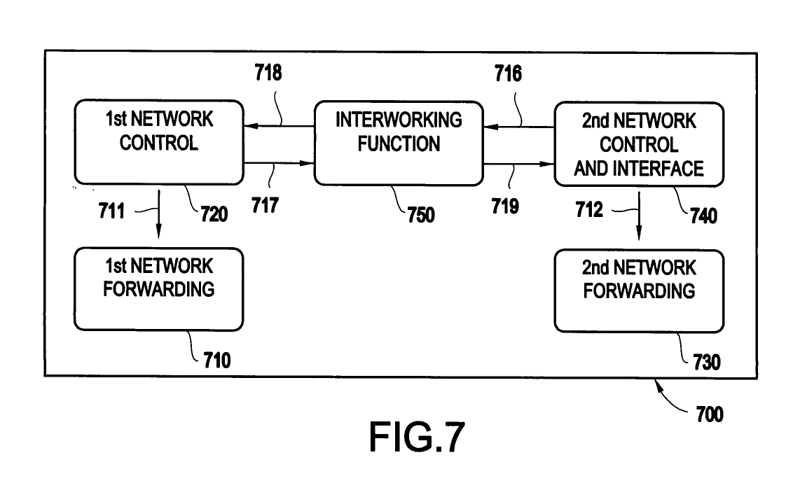

FIG. 7 illustrates a network element 700 according to a second exemplary embodiment of the present invention. As with the network element 200, the network element 700 provides an interworking between plural networks. Further, the network element 700 may be included in an apparatus and should not be construed as only being software-implemented but may also be implemented by hardware or a combination of software and hardware.

The network element 700 includes a first network forwarding function block 710 (e.g., a service network forwarding function block such as an IP/MPLS forwarding function block) for forwarding packets in a first network, a first network control function block 720 (e.g., a service network control function block such as an IP/MPLS control function block) for controlling the first network forwarding function block 710, a second network forwarding function block 730 (e.g., a transport network forwarding function block such as a layer 1 or layer 2 forwarding function block) for forwarding frames along a connection-oriented path in a second network, a second network control function block 740 (e.g., a transport network control function block such as a layer 1 or layer 2 control function block) for controlling the second network forwarding function block 730, and an interworking function block 750 (e.g., service instance/transport instance (S/TD) controller) for interworking with the first network and second network control function blocks 720, 740.

Similarly to the network element 200 in the first embodiment, in the network element 700, the first network control function block 720 (e.g., a service network control function block such as an IP/MPLS control function block) may control packet forwarding (711) (e.g., IP/MPLS packet forwarding) which is implemented in the first network forwarding function block 710 (e.g., a transport network forwarding function block such as an IP/MPLS forwarding function block, and the second network control function block 740 may control forwarding (712) of frames in the second network.

However, network element 700 may further include the interworking function block 750 which may provide a service instance and transport instance control function (e.g., a service instance control functionality) for interworking with the first network control function block 720 and the second network control function block.

The service instance control functionality of network element 700 may be described as follows. The second network control function block 740 may communicate (716) information such as transport instance information to the interworking function block 750, and the first network control function block 720 may communicate (717) information such as service instance information to the interworking function block 750.

The interworking function block 750 may look at the information it received (e.g., the parameters of service instance and parameters of transport instance received), and calculate parameters appropriate for the first network control function block 720 and the second network control function block 740 based on the parameters of service instances and parameters of transport instances received from the first network and second network control function blocks 720, 740.

For example, the interworking function block 750 may look at the bandwidth of total LSPs used in a connection-oriented path and/or the bandwidth of the connection-oriented path, and calculate bandwidth utilization of service instances (e.g., the LSPs) in the connection-oriented path, which is used by the second network control function block 740 so that the second network control function block 740 may increase the capacity of the connection-oriented path if the bandwidth utilization exceeds the threshold of the bandwidth utilization defined by the operators of the transport network.

Further, an important benefit of the present invention is that the interworking function block 750 may enable network operators of the second network (e.g., a transport network) to set their policies such as a bandwidth management policy of connection-oriented paths for managing the second network.

The interworking function block 750 can also calculate available bandwidth for service network paths such as MPLS paths by looking at vacant bandwidth in the connection-oriented path, which is used by the first network control function block 720.

Parameters of service instances may include, for example, the bandwidth of total LSPs in a connection-oriented path, route, and/or the number of LSPs in a connection-oriented path. The parameters of transport instances may include, for example, the bandwidth of a connection-oriented path and/or the priority in using connection-oriented paths with the same source and destination.

As also illustrated in FIG. 7, the interworking function block 750 may also communicate (718) the parameters calculated in the interworking function block 750 to the first network control function block 720, and may also communicate (719) the parameters calculated in the interworking function block 750 to the second network control function block 740.

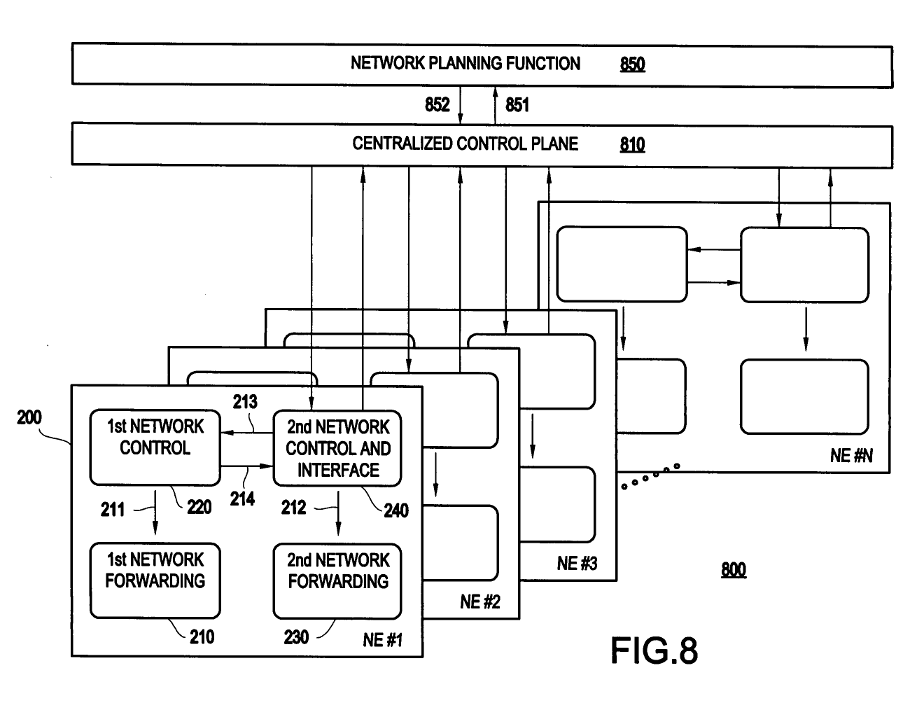

FIG. 8 illustrates a system 800 including a plural network elements 800 which provide an interworking function between plural networks, according to another exemplary embodiment of the present invention. The system 800 is similar to the system 300 described above, however, the system 800 may also provide a network planning function block 850 (e.g., network planning functionality) interworking with a centralized control plane 810. The network planning functionality may include, for example, 1) a plan for equipment to be added, and 2) a plan for building up a new network.

For network planning, centralized management is suitable since the cost needed for the new network or equipment needs to be minimized by an optimizing network not locally, but as a whole. An important benefit to adding interworking between the NEs 200 of the present invention and the network planning functionality through centralized control plane 810 is that operators of the second network (e.g., transport network) can plan the network effectively by monitoring the services in the second network as a whole accurately and in a timely manner.

As illustrated in FIG. 8, network information communicated from the second network control function block 240 (e.g., Layer 1 and/or Layer 2 control function block) of NEs 200 to the centralized control plane 810, in addition to network information which is originally controlled by the centralized control plane 810, may be communicated (851) to the network planning function block 850.

The information communicated from second network control function block 240 may include, for example, service information used in transport networks, such as the connection-oriented path used by the services and bandwidths of the services.

The information communicated (851) from the centralized control plane may include, for example, physical network information (e.g., fiber length and routes), link diversity information (e.g., Shared Risk Link Group), transmission performance (e.g., maximum transmission distance without regeneration), inventories (currently-available resources), etc.

Network information communicated from the second network control function block 240 to the centralized control plane 810 may provide correct service information in a timely manner, giving an accurate source of information for the network planning.

At the network planning function block 850, the transport network may be planned and designed based on the information obtained by the centralized control plane 810, a time horizon, and a service demand forecast. The accuracy of the service demand forecast can be improved if service information in the transport network is obtained with accuracy and in a timely manner. An algorithm such as a Dijkstra algorithm, a generic algorithm, or a heuristic algorithm can be used for the network design.

The planned network information may be communicated (852) to the centralized control plane 810 if the centralized control plane 850 uses the planned network information ( e.g., the equipment to be added, and the location where the equipment needs to be added).

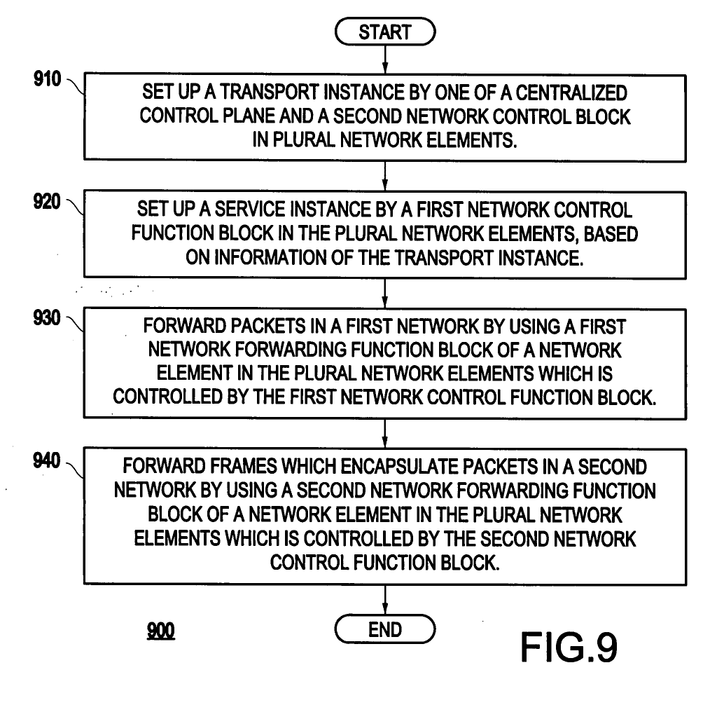

FIG. 9 illustrates a method 900 according to an exemplary aspect of the present invention. As illustrated in FIG. 9, the method 900 includes setting up (910) a transport instance (e.g., a connection-oriented path) by a centralized control plane or a second network control function block in plural network elements (e.g., a distributed control plane), setting up (920) a service instance (e.g., a label switched path (LSP)) by a first network control function block in the plural network elements, based on the information of the transport instance (e.g., the connection-oriented path), forwarding (930) packets in a first network by using a first network forwarding function block of a network element (in the plural network elements) which is controlled by the first network control function block, and forwarding (940) frames which encapsulate packets in a second network by using a second network forwarding function block of a network element (in the plural network elements) which is controlled by the second network control function block.

It should be noted that the order of the flow of features 910-940 in method 900 as depicted in FIG. 9 is merely illustrative and should not be considered as limiting.

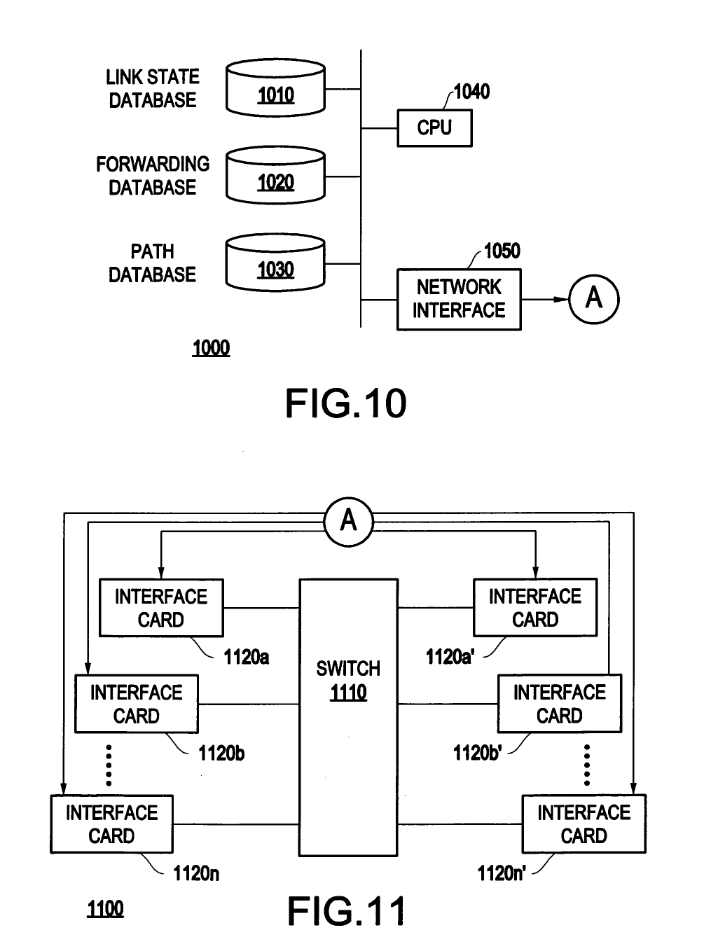

FIG. 10 illustrates a control function block 1000 (e.g., second network control function block 240) which may be included in the network element (e.g., network element 200), according to an exemplary aspect of the present invention.

As illustrated in FIG. 10, the control function block 1000 includes a link state database 1010 which may be used to store information related to a link state, a forwarding database 1020 which may be used to store tables for forwarding packets and/or frames, and a path database 1030 which may be used to store path information such as connection-oriented paths and label switched paths (LSPs). The control function block 1000 also includes a central processing unit 1040 which is connected to the databases 1010, 1020, 1030 (e.g., by a system bus) and may implement various calculations to control a forwarding function block of a network element, update information in a database (e.g., databases 1010, 1020, 1030), etc., and a network interface 1050.

FIG. 11 illustrates a forwarding function block 1100 (e.g., forwarding function block 230) which may be included in the network element (e.g., network element 200), according to an exemplary aspect of the present invention. The forwarding function block 1100 includes a switch 1110 for switching a path in a network and plural interface cards 1120a . . . 1120n and 1120a′ . . . 1120n′ which are connected to the network interface 1050 of the control function block 1000. It should be noted that the “A” in FIGS. 10 and 11 is used to indicate a connection between the network interface 1050 of the control function block 1000, and an interface card in the forwarding function block 1100.

In addition to the configuration of FIGS. 10 and 11 described above, a different aspect of the invention includes a computer-implemented method for performing a method (e.g., method 900) of the present invention. As an example, this method may be implemented in the configuration of FIGS. 10 and 11 described above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the method (e.g., method 900) of the present invention.

Such a method may be implemented, for example, by operating the CPU 1040 to execute a sequence of machine-readable instructions. These instructions may reside in various types of signal bearing media.

Thus, this aspect of the present invention is directed to a programmed product, including signal-bearing media tangibly embodying a program of machine-readable instructions executable by a digital data processor incorporating the CPU 1040 and hardware above to perform the method of the invention.

This signal-bearing media may include, for example, a RAM contained within the CPU 1040, as represented by the fast-access storage for example. Alternatively, the instructions may be contained in another signal-bearing media, such as a magnetic data storage diskette, directly or indirectly accessible by the CPU 1040.

With its unique and novel features, the present invention provides an apparatus including a network element providing an interworking function between plural networks including, for example, a service network which is managed by distributed management, and a transport network which is managed by a centralized management.

While the invention has been described in terms of one or more embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. An apparatus, comprising:
a network element providing an interworking function between plural networks, said network element comprising:
a first network forwarding function block for forwarding packets in a first network;
a first network control function block for controlling the first network forwarding function block;
a second network forwarding function block for forwarding frames along a connection-oriented path in a second network; and
a second network control function block for controlling the second network forwarding function block.

2. The apparatus of claim 1, wherein the second network control function block comprises a mechanism for communicating with a centralized control plane.

3. The apparatus of claim 1, wherein said interworking function is provided between said first network control function block and said second network control function block.

4. The apparatus of claim 1, wherein said first network comprises a service network and said second network comprises a transport network.

5. The apparatus of claim 4, wherein said service network is controlled by a distributed control plane, and said transport network is controlled by a centralized control plane.

6. The apparatus of claim 4, wherein said service network comprises an Internet Protocol/multi-protocol label switching (IP/MPLS) network and said transport network comprises one of a Layer 1 network and a Layer 2 network.

7. The apparatus of claim 1, wherein said first network control function block comprises a mechanism for recognizing a bandwidth of service instances and communicating said bandwidth to the second network control function block,
wherein the second network control function block comprises a mechanism for controlling a bandwidth of transport instances based on said bandwidth of the service instances communicated from the service network control function block, and a mechanism for communicating available bandwidth of transport instances to the service network control function block, and
wherein said first network control function block comprises a mechanism for communicating said available bandwidth to the service network.

8. The apparatus of claim 1, wherein said first network control function block supports a traffic engineering function comprising at least one of a link state advertising function and an explicit path designation function.

9. A system, comprising:
plural network elements providing an interworking function between plural networks, said plural network elements comprising:
a first network forwarding function block for forwarding packets in a first network;
a first network control function block for controlling said first network forwarding function block;
a second network forwarding function block for forwarding frames along a connection-oriented path in a second network; and
a second network control function block for controlling said second network forwarding function block; and
a centralized control plane in communication with said plural network elements.

10. The system of claim 9, wherein said second network control function block comprises a mechanism for communicating with said centralized control plane.

11. The system of claim 9, wherein said interworking function is provided between said first network control function block and said second network control function block.

12. The system of claim 9, wherein a bandwidth of the connection-oriented path is managed based on a bandwidth of label switched paths (LSPs) in the connection-oriented path, and
wherein the bandwidth of the LSPs in the connection-oriented path is communicated to said centralized control plane which one of creates a new connection-oriented path and expands a bandwidth of the connection-oriented path.

13. The system of claim 9, wherein the second network control function block comprises a mechanism for communicating with said centralized control plane, and a mechanism for operating based on orders from the centralized control plane, and
wherein the centralized control plane comprises a mechanism for collecting information from said plural network elements through said second network control function block, and a mechanism for ordering an operation to said plural network elements by ordering the operation to the second network control function blocks of the plural network elements.

14. The system of claim 9, wherein said plural network elements comprise:
first and second network elements which form edges of the connection-oriented path, and function as a router in setting up label switched paths (LSPs) into the connection-oriented path, using a first network control function block functionality; and
a third network element which forwards packets between said first and third network elements by the connection-oriented path, without processing a header on said packets.

15. The system of claim 14, wherein said connection-oriented path comprises a first path for a first service instance, and a second path for a second service instance, and a bandwidth of said first service instance is controlled independently of a bandwidth of said second service instance.

16. The system of claim 14, wherein said connection-oriented path includes a first service instance and a second service instance, and a bandwidth of said first service instance is controlled independently of a bandwidth of said second service instance by setting a maximum bandwidth of said first and second service instances separately in the network elements which form edges of the connection-oriented path.

17. The system of claim 14, wherein said connection-oriented path comprises:
a first path for a first service instance, and a second path for a second service instance, a bandwidth of said first service instance being controlled independently of a bandwidth of said second service instance; and
a third path for managing control packets, such that a bandwidth used for the control packets is limited to a bandwidth of the third path.

18. The system of claim 9, further comprising:
a first router for routing packets to said plural network elements; and
a second router for receiving packets which are forwarded by said plural network elements.

19. The system of claim 18, wherein said second network forwarding function block in said plural network elements comprises said connection-oriented path which forwards packets from said first router to said second router.

20. The system of claim 19, wherein said interworking function is provided between said first network control function block and said second network control function block, and enables said first network control function block to find a connection-oriented path available for forwarding packets, and an available bandwidth of said connection-oriented path for forwarding packets is communicated to said first router by using a routing protocol.

21. The system of claim 20, wherein said first network control function block receives a signal from said first router, said signal comprising bandwidth information of a label switched path (LSP), and said bandwidth information is communicated to said second network control function block which controls a bandwidth of the connection-oriented path based on said bandwidth information.

22. The system of claim 21, wherein said connection-oriented path is set up between said plural network elements by said centralized control plane, and attributes of said connection-oriented path are communicated to said first and second routers by using a routing protocol, and
wherein said first and second routers set up a label switched path (LSP) based on the attributes of the connection-oriented path.

23. The system of claim 9, further comprising:
a network planning function device for receiving information from said centralized control plane and planning said second network based on said information, and communicating network planning information to said centralized control plane.

24. An apparatus, comprising:
a network element providing an interworking function between plural networks, said network element comprising:
a first network forwarding function block for forwarding packets in a first network;
a first network control function block for controlling said first network forwarding function block;
a second network forwarding function block for forwarding frames along a connection-oriented path in a second network;
a second network control function block for controlling said second network forwarding function block; and
an interworking function block for interworking with said first network and second network control function blocks.

25. The apparatus of claim 24, wherein said interworking function block calculates a parameter comprising bandwidth utilization of a service instances in the connection-oriented path.

26. The apparatus of claim 24, wherein said second network control function block communicates a transport instance parameter to the interworking function block, and said first network control function block communicates a service instance parameter to the interworking function block.

27. The apparatus of claim 26, wherein, based on said service instance parameter and said transport instance parameter, the interworking function block calculates a first network parameter and communicates said first network parameter to said first network control function block, and calculates a second network parameter and communicates said second network parameter to said second network control function block.

28. The apparatus of claim 26, wherein said service instance parameter comprises one of a bandwidth of total label switched paths (LSPs) in a connection-oriented path, a route, and a number of LSPs in the connection-oriented path, and
wherein said transport instance parameter comprises one of a bandwidth of a connection-oriented path and priority in using connection-oriented paths with the same source and destination.

29. A method, comprising:
setting up a transport instance by one of a centralized control function block and a second network control function block in plural network elements;
setting up a service instance by a first network control function block in said plural network elements, based on information of the transport instance;
forwarding packets in a first network by using a first network forwarding function block of a network element in said plural network elements which is controlled by the first network control function block; and
forwarding frames which encapsulate packets in a second network by using a second network forwarding function block of a network element in said plural network elements which is controlled by the second network control function block.

30. A programmable storage medium tangibly embodying a program of machine-readable instructions executable by a digital processing apparatus to perform the method of claim 29.
